(19) United States
(12) Patent Application Publication
(10) Pub. No.: US 2009/0103940 A1
(43) Pub. Date: Apr. 23, 2009

(54) Image forming device

(75) Inventors: Norio Tomiie, Osaka (JP); Shinki Miyaji, Osaka (JP)

Correspondence Address: JORDAN AND HAMBURG LLP, 122 EAST 42ND STREET, SUITE 4000, NEW YORK, NY, 10168, US

(73) Assignee: KYOCERA MITA CORPORATION, Chuo-ku (JP)

(21) Appl. No.: 12/286,573

(22) Filed: Oct. 1, 2008

(30) Foreign Application Priority Data
Oct. 22, 2007 (JP) 2007-274286

(51) Int. Cl. G03G 15/00

(52) U.S. Cl. 399/89

(57) ABSTRACT

A tandem image forming device includes: a high voltage generating circuit for applying an oscillating voltage to a charging member disposed in contact with or proximity to an image carrier, the oscillating voltage having a DC voltage and an AC voltage superimposed thereon; a voltage control portion for controlling the peak-to-peak voltage of the AC voltage at a target voltage, the image forming device changing by switching a process speed depending on monochrome image formation and color image formation; a current detecting portion for detecting the value of a DC current between the image carrier and the charging member; and a frequency switching portion for switching the frequency of the AC voltage between frequencies according to the process speed. The voltage control portion includes an initial voltage adjusting portion for adjusting the target voltage on the basis of the value of the DC current detected by the current detecting portion.

This application is based on applications No. 2007-274286 and No. 2006-013891 filed in Japan, the contents of which are hereby incorporated by reference.

### BACKGROUND OF THE INVENTION

1. Field of the Invention

The present invention relates to a tandem image forming device including: a high voltage generating circuit for applying an oscillating voltage to a charging member disposed in contact with or proximity to an image carrier, the oscillating voltage having a DC voltage and an AC voltage superimposed thereon; and a voltage control portion for controlling the peak-to-peak voltage of the AC voltage at a target voltage, wherein the image forming device changes by switching the process speed depending on monochrome image formation and color image formation.

2. Description of the Related Art

Charging control devices mounted in recent image forming devices are dominantly of the contact charging system, where a charging member in the form of a roller, a blade, and the like is disposed in contact with or proximity to an image carrier surface, and the charging member is applied an oscillating voltage having a DC voltage and an AC voltage superimposed thereon, thereby uniformly charging the image carrier surface. The contact charging system is in the mainstream because of considerations including the voltage reducing process of reducing the charging control voltage to the image carrier, a reduction in ozone that occurs during charging control, and cost reduction. The oscillating voltage is not limited to a sine wave, but any periodically changing, oscillating wave may be used such as a rectangular wave, a triangular wave, and a pulse wave.

Japanese Unexamined Patent Publication No. 63-149668 discloses charging properties of the contact charging system including the following:

If the AC voltage of the oscillating voltage increases its peak-to-peak voltage, then the charge voltage of the image carrier increases in proportion thereto; if the peak-to-peak voltage reaches a level that is substantially twice the voltage at which the charge starts with the DC voltage, then the charge potential is saturated, and no further voltage increase will change the charge potential; in order to secure charge uniformity, the peak-to-peak voltage of the applied oscillating voltage must be at least twice the voltage at which the charge starts with application of the DC voltage, which is determined by, for example, the properties of the image carrier; and the obtained charge voltage depends on the DC component of the applied voltage.

Japanese Unexamined Patent Publication No. 2001-201921 discloses a technique to prevent problems including deterioration of the image carrier, toner fusing, and image deletion, by securing constant discharge by preventing excessive discharge irrespective of manufacture variations of resistance of charging members and resistance fluctuations due to environment.

Specifically, the reference discloses a charge control method that determines the peak-to-peak voltage of the AC voltage applied to the charging member during image formation, on the basis of AC current values measured during a period of time other than image formation, the AC current values including the value of the AC current through the charging member when the charging member has been applied one or more peak-to-peak voltage of less than twice the discharge starting voltage Vth, and the values of the AC current through the charging member when the charging member has been applied two or more peak-to-peak voltages of equal to or more than twice the discharge starting voltage Vth. As used herein, the discharge starting voltage Vth refers to a discharge starting voltage to the image carrier at the time when a DC voltage is applied to the charging member.

However, the technique disclosed in the JP2001-201921 publication requires a complex, expensive AC current detecting circuit for detecting the AC current between the image carrier and the charging member.

In view of this, the Applicants of this application proposed in Japanese Unexamined Patent Publication Nos. 2006-171281 and 2007-199094 (the JP publication 2007-199094 corresponds to the above-referenced application No. 2006-013891) use of a relatively cheap DC current detecting circuit so as to detect the DC current Idc between the charging member and the image carrier and minimize the peak-to-peak voltage of the AC voltage on the basis of the DC current Idc.

This image forming device includes a charging member disposed in contact with or proximity to an image carrier and for carrying out charging treatment of the image carrier, a high voltage generating circuit for applying to the charging member an oscillating voltage having a DC voltage and an AC voltage superimposed thereon, and a voltage control portion for controlling the peak-to-peak voltage Vpp of the AC voltage.

Referring to FIG. 15, the voltage control portion first obtains a line L1 passing through coordinate points A (Vpp(A), Idc(A)) and B (Vpp(B), Idc(B)) on an assumed characteristic curve that represents the relationship between the peak-to-peak voltage Vpp and the DC current Idc on a two-dimensional coordinate system. The coordinate points A and B are respectively determined by DC current values Idc(A) and Idc(B) when two different low voltage-side peak-to-peak voltages Vpp(A) and Vpp(B) are applied to the charging member in an area of lower voltage than the voltage value of an inflection point that appears when the peak-to-peak voltage Vpp increases.

The voltage control portion next obtains a line L2 parallel to the coordinate axis for the peak-to-peak voltage Vpp and passing through a coordinate point C (Vpp(C), Idc(C)) on the assumed characteristic curve, the coordinate point C being determined by a DC current value Idc(C) when a single high voltage-side peak-to-peak voltage Vpp(C) is applied in an area of higher voltage than the voltage value of the inflection point.

The voltage control portion then obtains a peak-to-peak voltage Vpp corresponding to the intersection of the lines L1 and L2 as a proper peak-to-peak voltage Vpp(O), and sets the peak-to-peak voltage Vpp of the AC voltage at the peak-to-peak voltage Vpp(O).

Generally, the image forming devices of the contact charging system suffer charge irregularities along the circumference of the image carriers depending on the frequency of the AC voltages applied to the charging members.

These charge irregularities that occur periodically might have mutual interference with, for example, a development frequency caused by the pitch of magnetic poles on the magnet roll or an AC developing bias in the developer, and with a screen frequency component contained in output image data that is subjected to screening, resulting in possibilities of moire.

In view of this, the frequency of the AC voltage applied to the charging member is usually set at ones that eliminate the possibility of the above interference according to the process speed.

However, some of the tandem image forming devices, which are a recent focus of attention, are adapted to switch the process speed between different speeds depending on color image formation, where high image quality is required, and monochrome image formation, where rapidness is required. This requires, to avoid the above interference, changing the frequency of the AC voltage in response to the switching of the process speed.

However, when epichlorohydrin rubber is employed for the material of the charging member, the charging member shows a property of fluctuating its impedance due to ambient temperature, the frequency of the applied voltage, and aging.

In particular, if the impedance of the charging member fluctuates due to the frequency of the applied voltage, when an AC voltage with a frequency set according to a process speed has its peak-to-peak voltage set so as to render the charge potential of the image carrier a proper value and this peak-to-peak voltage value is applied as a peak-to-peak voltage for an AC voltage with a frequency set according to a different process speed, then it was difficult to adjust the charge potential of the image carrier to the proper value.

Further, if the frequency of the AC voltage varies, the fluctuation of the impedance of the charging member causes a property shift to the control voltage for the high voltage generating circuit in obtaining a desired peak-to-peak voltage, thereby making it difficult to properly set the control voltage.

For example, in a tandem image forming device including an image carrier having a photoreceptor layer of amorphous silicon and a charging member of epichlorohydrin rubber that is contact with the image carrier at a predetermined pressure, when the frequency of the AC voltage is set at 1600 Hz to correspond to the process speed during color image formation, then a stable charge potential of approximately 300 V is obtained at a peak-to-peak voltage of approximately 1000V for the AC voltage, as shown in FIG. 13A.

However, when the frequency of the AC voltage is switched to 2200 Hz to correspond to the process speed during monochrome image formation, the peak-to-peak voltage of the AC voltage must be increased to approximately 1400 V.

In both cases, setting the peak-to-peak voltage at approximately 1600 V including a margin in an attempt to secure a stable charge potential results in application of an excessive level of AC voltage, especially during color image formation.

Referring to FIG. 13B, when the peak-to-peak voltage exceeds 1000 V, the ozone concentration gradually increases to increase discharge products and thus increase attachment thereof to the image carrier, with the result that the dynamic friction coefficient μ of the image carrier tends to increase drastically, as shown in FIG. 14.

This increases the possibility of inconveniences including image deletion due to lateral charge leakage and mal-cleaning that allows toner to slip through the cleaner.

These problems are relatively minor when the image carrier uses a soft organic photoconductor (OPC), which has relatively low surface hardness, because the attached discharge products are removed together with the surface layer that wears gradually through contact with the cleaner blade and the like.

However, the attached discharge products are not easily removable when the image carrier uses an amorphous silicon photoreceptor because it has a hard surface layer providing extraordinary wear resistance.

Thus, a tandem image forming device that employs amorphous silicon, which has a hard surface layer and temperature dependency among its charge properties, as the image carrier and that is adapted to change the frequency of the AC voltage according to the switching of the process speed is still not in practice.

### SUMMARY OF THE INVENTION

In view of the foregoing problems, an object of the present invention is to provide a tandem image forming device capable of setting a proper peak-to-peak voltage instead of applying an excessive peak-to-peak voltage to the charging member during the switching of the AC voltage applied to the charging member in response to the switching of the process speed depending on monochrome image formation and color image formation.

In order to accomplish the above object, an image forming device according to the present invention includes: a high voltage generating circuit for applying an oscillating voltage to a charging member disposed in contact with or proximity to an image carrier, the oscillating voltage having a DC voltage and an AC voltage superimposed thereon; and a voltage control portion for controlling a peak-to-peak voltage of the AC voltage at a target voltage, the image forming device switching a process speed depending on monochrome image formation and color image formation. The image forming device is characterized in including: a current detecting portion for detecting the value of a DC current between the image carrier and the charging member; and a frequency switching portion for switching a frequency of the AC voltage between frequencies according to the process speed, and that the voltage control portion includes an initial voltage adjusting portion for adjusting the target voltage on the basis of the value of the DC current detected by the current detecting portion.

The present invention will become more apparent in the detailed description of the preferred embodiments presented below.

### BRIEF DESCRIPTION OF THE DRAWINGS

FIG. 1 is a block diagram for illustrating main functions of an image forming portion and an image forming control portion that relate to the present invention;

FIG. 2 is a graph showing a relation of peak-to-peak voltage and DC current;

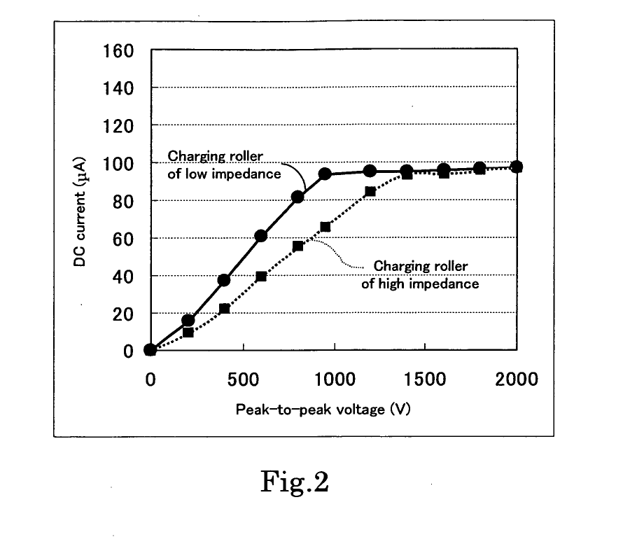

FIG. 3 is a functional block diagram of a color digital copier;

FIG. 4A is a diagram for illustrating the image forming portion, and FIG. 4B is a diagram for illustrating an image forming unit;

FIG. 5 is a diagram for illustrating control portions;

FIG. 6 is a diagram for illustrating a DC voltage power source;

FIG. 7 is a diagram for illustrating a shunt regulator;

FIG. 8 is a diagram for illustrating an AC voltage power source;

FIG. 9 is a diagram for illustrating a current detecting portion;

FIG. 10A is a graph showing a relation of control voltage and peak-to-peak voltage, and FIG. 10B is a graph showing a relation of peak-to-peak voltage and the amount of variation of DC current;

FIG. 11 is a flowchart for describing a target voltage adjusting operation by an initial voltage adjusting portion;

FIG. 12 is a graph showing a relation of charge potential and the peak-to-peak voltage of AC voltage on a frequency basis;

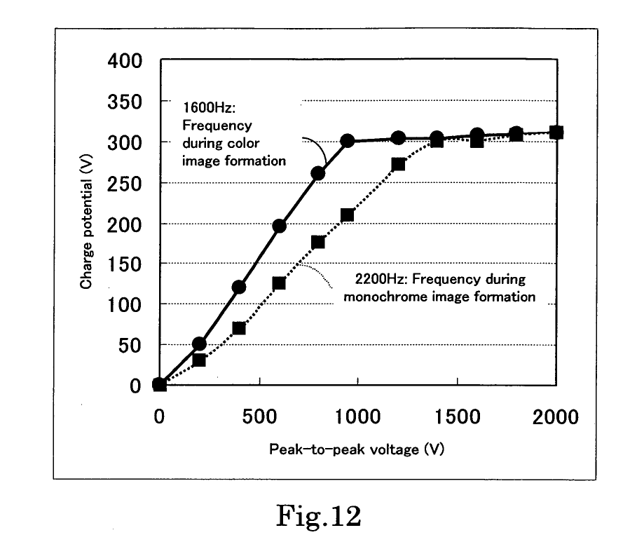

FIG. 13A is a graph showing a relation of peak-to-peak voltage and charge potential, and FIG. 13B is a graph showing a relation of peak-to-peak voltage and ozone concentration;

FIG. 14 is a graph showing a relation of peak-to-peak voltage and the dynamic friction coefficient of an image carrier; and

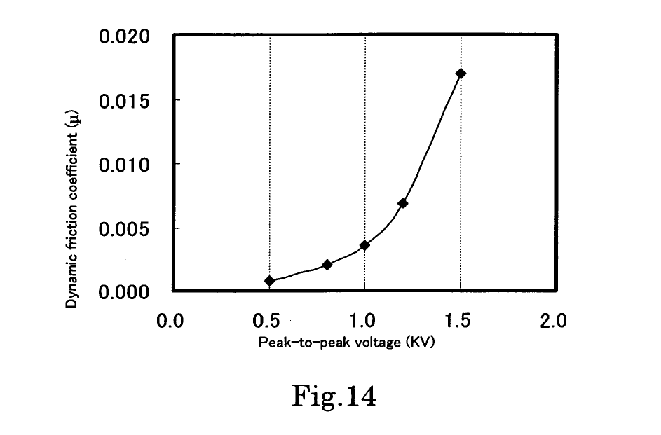

FIG. 15 is a graph showing a relation of peak-to-peak voltage and DC current.

### DESCRIPTION OF THE PREFERRED EMBODIMENTS

A color digital copier according to an embodiment of the image forming device of the present invention will be described below.

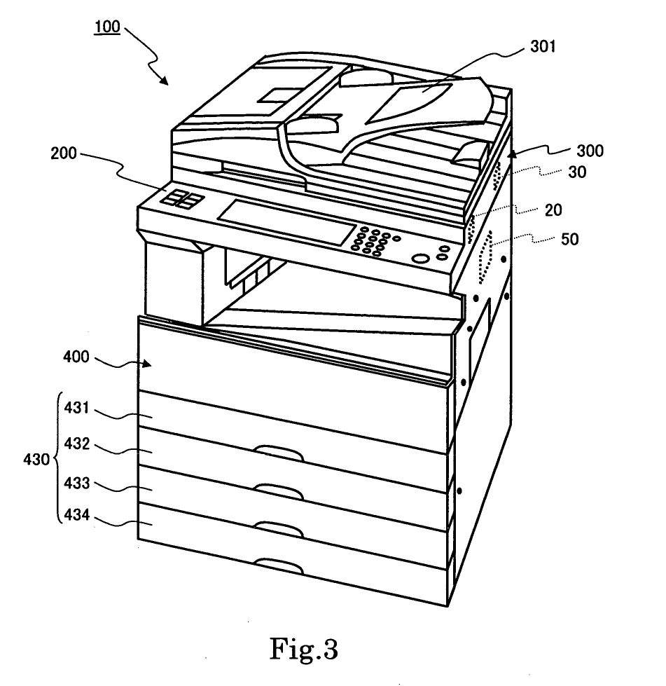

Referring to FIG. 3, a tandem color digital copier 100 of an electro-photographic mode includes functional blocks including an operating portion 200 that serves as a man-machine interface with operators, an image reading portion 300 that reads a document image by photoelectrically converting the document image into image data, and an image forming portion 400 that forms a toner image on a photoreceptor on the basis of the image data read by the image reading portion 300, transfers and fixes the toner image onto a sheet, and outputs the sheet.

The operating portion 200 includes: a touch-panel type liquid crystal display portion that displays, as well as the operational status of the digital copier 100, an operation screen with a plurality of arranged operational software keys; a plurality of operational hardware keys; and an operating control portion 20 that controls the foregoing.

The image reading portion 300 includes: an automatic document feeder that sequentially feeds sheets placed on a document feeding tray 301; a light source that focuses light onto the document; an imaging element such as CCD that reads the document image by photoelectrically converting reflection light incident from the document through an optical system; and an image reading control portion 30 that controls the foregoing.

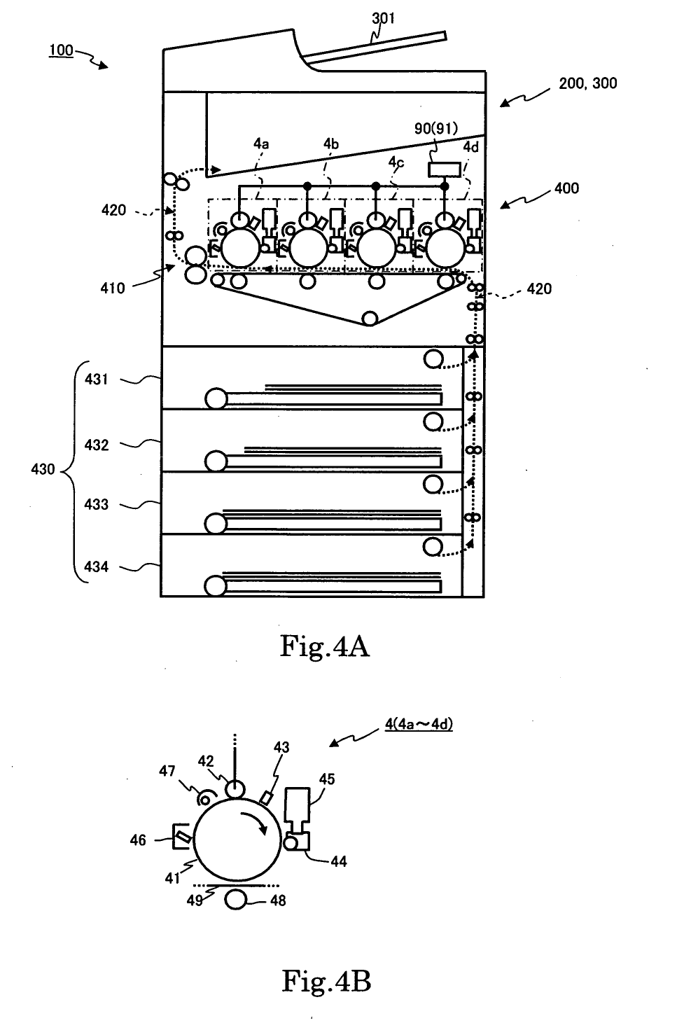

Referring to FIG. 4A, the image forming portion 400 includes four image forming units 4 (4a, 4b, 4c, 4d) corresponding to yellow Y, magenta M, cyan C, and black K, and an image forming control portion 40 that controls the foregoing.

Referring to FIG. 4B, each image forming unit 4 includes an image carrier 41, a charging member 42, a print head 43, a developing portion 44, a toner cartridge 45, a cleaner 46, and an eraser lamp 47, which are disposed around the image carrier 41 in this order.

The charging member 42 is disposed in contact with the image carrier 41 to subject it to charging treatment. The print head 43 forms an electrostatic latent image onto the image carrier 41 by irradiating it with light on the basis of the image data read by the image reading portion 300. The developing portion 44 turns the electrostatic image into a visible, toner image by electrostatically fixing to the electrostatic image a toner supplied from the toner-filled cartridge 45. The cleaner 46 removes residual toner on the photoreceptor after the toner image formed on the image carrier 41 has been transferred to a sheet. The eraser lamp 47 discharges residual potential.

The image carrier 41 is composed of an aluminum cylinder and a photoconductive amorphous silicon layer deposited on the surface of the cylinder and exhibiting positive charge properties. The charging member 42 is a charging roller composed of a metal core 42a and, as an elastic material, a conductive epichlorohydrin rubber layer 42b covering the metal core 42a.

A sheet stored in any of a plurality of paper drawers (431-434) constituting a paper storage portion 430 is transferred to the image forming portion 400 through a conveyer mechanism 42 including paper feeding rollers and a conveyer belt 49.

The toner image made visible at the image forming units 4 is transferred to the sheet at a transfer roller 48 that is applied a transfer bias voltage, and the toner-bearing sheet is fused and fixed at a fixing portion 410 including a fixing roller and a pressure roller, and then output.

The operating control portion 20, the image reading control portion 30, and the image forming control portion 40 are each composed of a micro computer mounting therein a ROM storing a control program and control data and a RAM to serve as a working area, and a control substrate mounting thereon peripheral circuits such as an interface circuit.

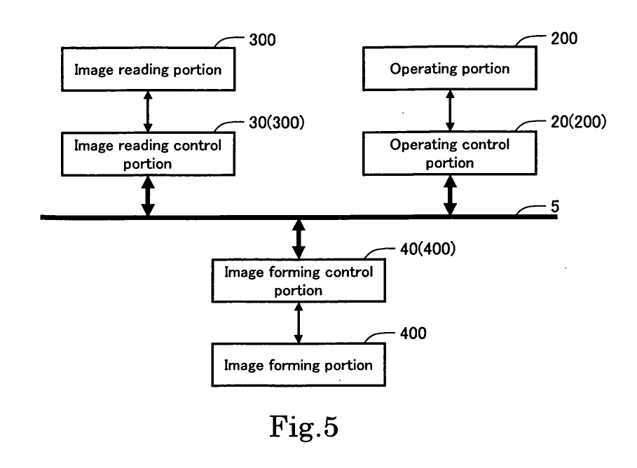

Referring to FIG. 5, these control portions are connected to each other through a communication bus 5, which mediates between them in exchanging control data necessary for the control that each control portion assumes. The micro computer of each control portion controls its control object on the basis of the control program stored in the ROM.

The color digital copier 100 is adapted to switch its process speed between different values depending on monochrome image formation and color image formation. The process speed encompasses the rotational speed of the image carrier, the scanning speed of the print head, and the speed of sheet conveyance by the conveyer mechanism. The process speed during monochrome image formation, where rapidness is required, is set higher than the process speed during color image formation, where high image quality is required.

During monochrome image formation and color image formation, the image forming control portion 40 changes by switching the rotational speed of each of the motors that drive the image carrier, the print head, and the like, thus adjusting the process speed to the one that corresponds to monochrome image formation or color image formation.

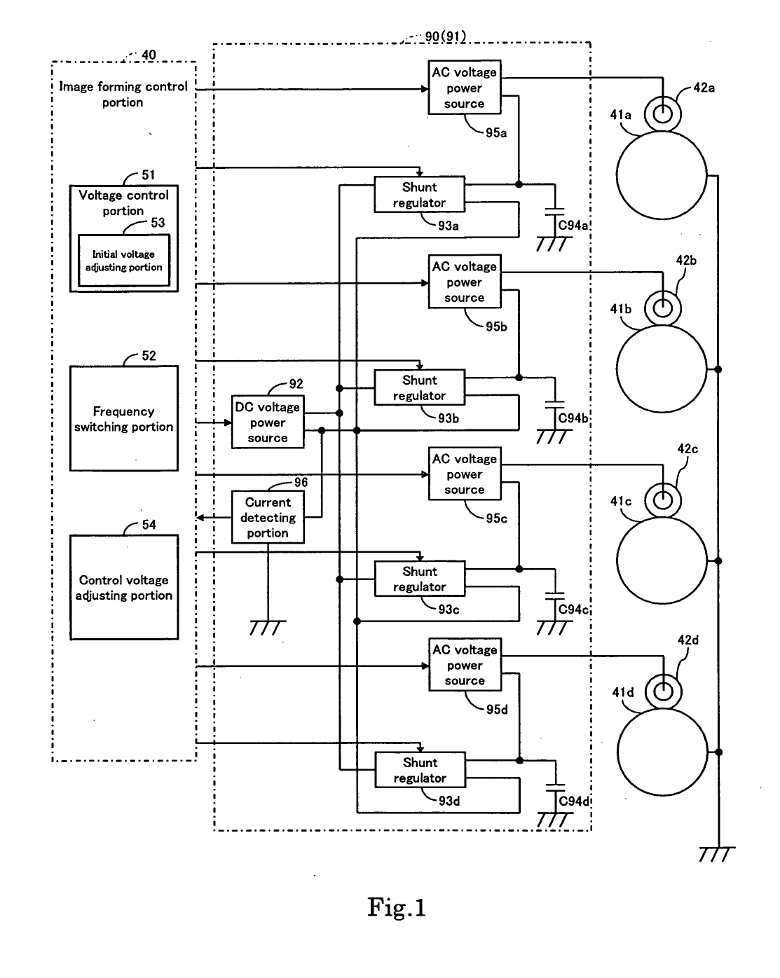

Referring to FIG. 1, on a substrate 90 provided in the image forming portion 400, a high voltage generating circuit 91 is mounted for charging the image carrier 41 by applying a high voltage to the charging member 42.

The high voltage generating circuit 91 includes a DC voltage power source 92 for outputting a high DC voltage, a shunt regulator 93 (93a, 93b, 93c, 93d) coupled to the output terminal of the DC voltage power source 92 and for outputting a predetermined DC voltage Vdc with the use of the high DC voltage, and an AC voltage power source 95 (95a, 95b, 95c, 95d) coupled to the output terminal of the shunt regulator 93 (93a, 93b, 93c, 93d) and for outputting an oscillating voltage having an AC voltage Vac superimposed on the DC voltage Vdc input from the shunt regulator 93 (93a, 93b, 93c, 93d) through a capacitor C94 (C94a, C94b, C94c, C94d).

The substrate 90 further includes a current detecting portion 96 for detecting the value of current between the image carrier 41 (41a, 41b, 41c, 41d) and the charging member 42 (42a, 42b, 42c, 42d).

The image forming control portion 40 includes a voltage control portion 51 for, by controlling the high voltage generating circuit 91, adjusting the peak-to-peak voltage of the AC voltage Vac applied to the charging member 42 at a target voltage, and a frequency switching portion 52 for switching the frequency of the AC voltage Vac between frequencies according to the process speed.

The voltage control portion 51 includes an initial voltage adjusting portion 53 for adjusting the target voltage on the basis of the value of the DC current detected by the current detecting portion 96.

The term “target voltage” refers to a peak-to-peak voltage of the AC voltage Vac required for setting the charge potential of the image carrier 41 at a predetermined charge potential when the DC voltage Vdc is set at a preset voltage.

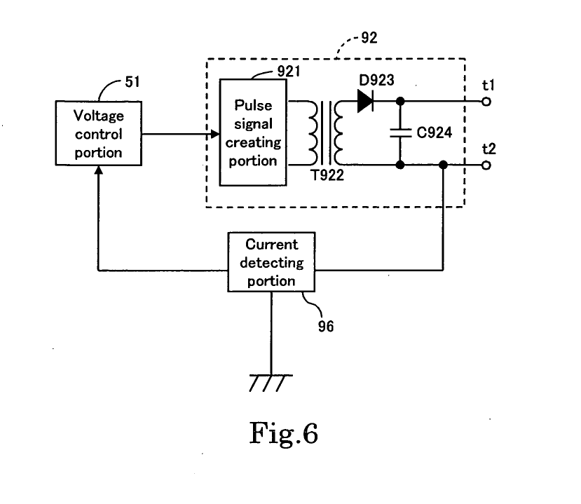

Referring to FIG. 6, the DC voltage power source 92 includes a pulse signal creating portion 921, a pulse transformer T922, and a smoothing circuit.

The pulse signal creating portion 921 outputs a pulse signal with a frequency corresponding to the value of the control voltage input from the voltage control portion 51. The pulse transformer T922 receives on a primary winding a pulse signal input from the pulse signal creating portion 921 and outputs from a secondary winding a high AC voltage enhanced to a predetermined voltage value. The smoothing circuit includes a diode D923 and a capacitor C924 so as to smooth the high AC voltage output from the transformer T922 and output a predetermined high DC voltage.

The shunt regulators 93a to 93d are coupled in parallel between the output terminal of the DC voltage power source 92 and the ground in order to apply DC voltage Vdc individually to the charging member 42 of each of the image forming units 4.

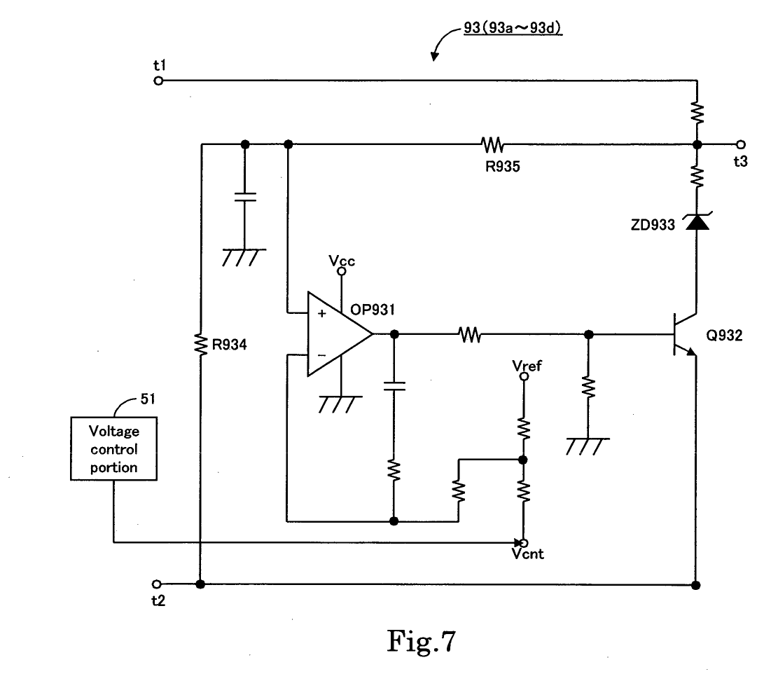

Referring to FIG. 7, each shunt regulator 93 includes an operational amplifier OP931 serving as a differential amplifier, a transistor Q932 driven by the output current of the operational amplifier OP931, and a Zener diode ZD933 coupled to the collector of the transistor Q932 and having a predetermined breakdown voltage.

The DC voltage Vdc output from the shunt regulator 93 is divided by resistors R934 and R935, and the divided voltage is input to the non-inverting input terminal of the operational amplifier OP931. To the inverting input terminal of the operational amplifier OP931 is input a reference voltage.

Thus, the operational amplifier OP931 supplies a base current to the transistor Q932 in such a manner that the reference voltage and the divided voltage are equal to one another. As a result, the DC voltage Vdc is adjusted by a current through the Zener diode ZD933.

The reference voltage is variable by being adjusted by a comparative voltage Vref set to a fixed value in advance and a control voltage Vcnt controlled by the voltage control portion 51.

The image carrier 41 (41a, 41b, 41c, 41d) includes a ROM that stores the value of a DC voltage necessary for setting a predetermined charge potential for the image carrier 41 (41a, 41b, 41c, 41d). The voltage control portion 51 reads the data in the ROM and controls the control voltage Vcnt to adjust the DC voltage Vdc applied to the charging member 42 to the read DC voltage value.

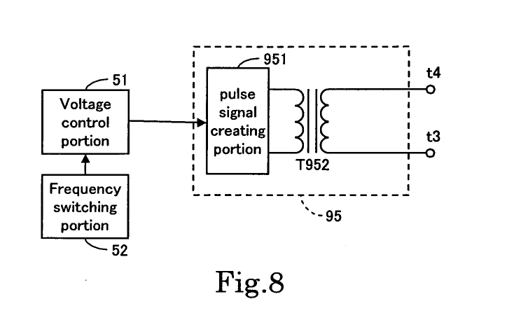

Referring to FIGS. 1 and 8, the AC voltage power sources 95a, 95b, 95c, and 95d respectively correspond to the charging members 42a, 42b, 42c, and 42d of the image forming units 4 and disposed in series respectively with the shunt regulators 93a, 93b, 93c, and 93d.

The AC voltage power source 95 includes a pulse signal creating portion 951 for outputting a pulse signal with a predetermined frequency that corresponds to the control signal input from the voltage control portion 51, and a pulse transformer T952 for receiving on a primary winding the pulse signal input from the pulse signal creating portion 951 and outputting from a secondary winding an AC voltage Vac with a desired peak-to-peak voltage.

The frequency switching portion 52 changes by switching, through the voltage control portion 51, the frequency of the AC voltage Vac output from the pulse transformer T952.

Specifically, when the frequency switching portion 52 inputs a frequency switching demand signal to the voltage control portion 51 according to the process speed, then the voltage control portion 51 inputs to the pulse signal creating portion 951a control voltage that corresponds to the frequency switching demand signal, and the pulse transformer T952 outputs an AC voltage Vac with a frequency that corresponds to the process speed.

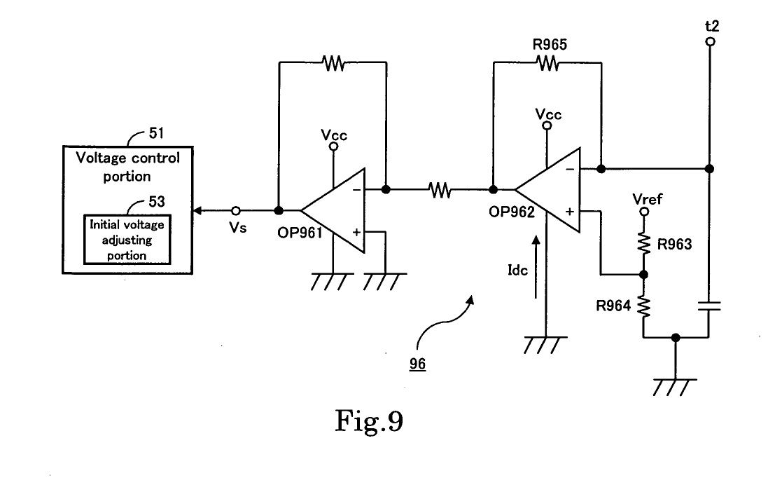

Referring to FIG. 9, the current detecting portion 96 includes an operational amplifier OP962 for current-voltage conversion and an operational amplifier OP961 for amplification.

The inverting input terminal of the operational amplifier OP962 is coupled to a secondary winding side low voltage terminal t2 of the DC voltage power source 92, and the non-inverting input terminal of the operational amplifier OP962 is coupled to the node of a resistor R963 and a resistor R964. The comparative voltage Vref is divided by the resistor R963 and the resistor R964 and input to the non-inverting input terminal of the operational amplifier OP962 as a reference voltage.

A current flows through a resistor R965 for feedback in such a manner that the reference voltage input to the operational amplifier OP962 and the voltage of the secondary winding side low voltage terminal t2 are equal to one another. This current is converted into a voltage and then output.

This current is a DC current from each charging member 42 to the ground through the image carrier 41, that is, a DC current Idc between the image carrier 41 and the charging member 42. The DC current Idc is converted into a voltage at the operational amplifier OP962 and amplified at the following operational amplifier OP961, and then input to the initial voltage adjusting portion 53.

The current detecting portion 96 is common and therefore cannot detect simultaneously and individually the DC currents Idc between the image carriers 41 and the charging members 42 of the image forming units 4.

In view of this, the initial voltage adjusting portion 53, when adjusting the peak-to-peak voltage of the AC voltage Vac applied to the charging member 42 of an image forming unit 4 to a target voltage, adjusts through the voltage control portion 51 the DC voltages Vdc output from all the shunt regulators 93 except the shunt regulator 93 corresponding to the charging member 42 concerned in such a manner that the DC voltages Vdc are lower than a discharge starting voltage, and turns off the AC voltages Vac output from all the AC voltage power sources 95 except the AC voltage power source 95 corresponding to the charging member 42 concerned.

Thus, the initial voltage adjusting portion 53 acquires the DC currents Idc necessary for adjusting the target voltages by detecting them individually from the current detecting portion 96.

The initial voltage adjusting portion 53 is activated when power is supplied to the color digital copier 100 or when the color digital copier 100 returns from a power saving mode, and sequentially adjusts the target voltages for the charging members mounted in the image forming units 4 through the voltage control portion 51.

Since the impedance of the charging member 42 changes according to the frequency of the AC voltage Vac, the initial voltage adjusting portion 53 adjusts the target voltage for every frequency switched by the frequency switching portion.

The initial voltage adjusting portion 53 first causes the frequency switching portion 52 to switch the frequency of the AC voltage Vac to a frequency corresponding to a process speed during color image formation, and adjusts the target voltage for the charging member mounted in each of the image forming units 4.

The initial voltage adjusting portion 53 next causes the frequency switching portion 52 to switch the frequency of the AC voltage Vac to a frequency corresponding to a process speed during monochrome image formation, and adjusts the target voltage for the charging member mounted in each of the image forming units 4.

A value of the control voltage output from the voltage control portion 51 does not always result in the same peak-to-peak voltage of the AC voltage Vac applied to the charging member 42 because the impedance of the charging member 42 changes depending on the frequency of the AC voltage Vac.

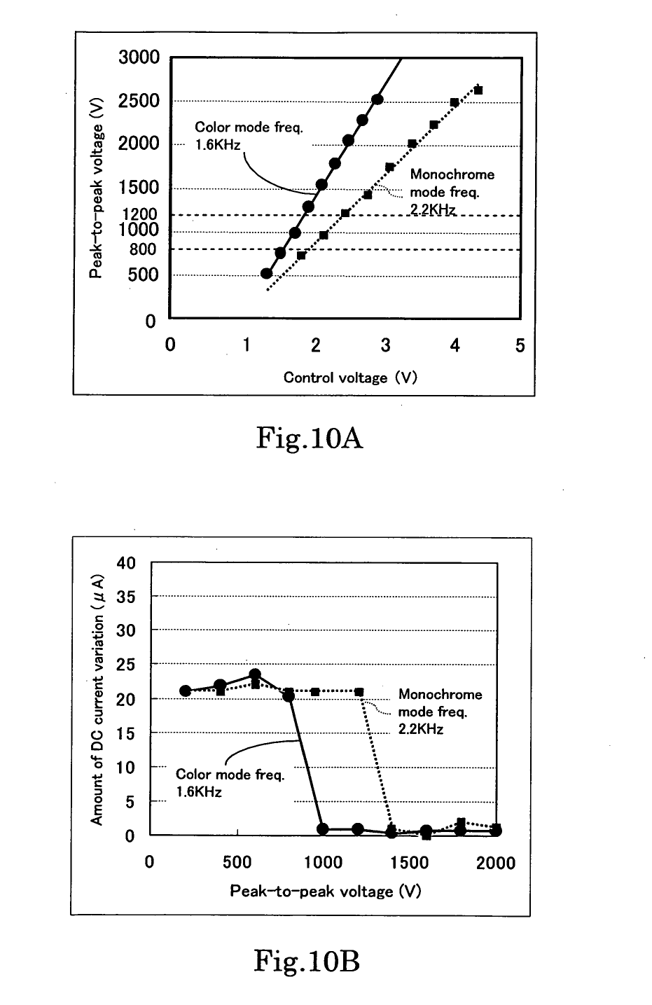

However, referring to FIG. 10A, experiments show that for each of the frequencies corresponding to the process speeds, there is a constant correlation between the control voltage and the peak-to-peak voltage of the AC voltage Vac.

In view of this, the image forming control portion 40 includes a control voltage adjusting portion 54 for converting, on the basis of the above correlation, a control voltage for adjusting the target voltage at one of the frequencies into a control voltage for adjusting the target voltage at another frequency.

On the basis of a correlation function or a conversion table stored in the ROM, the control voltage adjusting portion 54 calculates the control voltage for adjusting the target voltage at the other frequency from the control voltage for adjusting the target voltage at the one frequency.

That is, the ROM stores a correlation function or a conversion table with which to convert the control voltage for adjusting the target voltage at the one frequency into the control voltage for adjusting the target voltage at the other frequency.

Formula 1 is a correlation function f (Vsc) with which to convert a control voltage Vsc corresponding to the process speed during color image formation into a control voltage Vsm corresponding to the process speed during monochrome image formation. The characters A and B in the formula denote constants determined on the basis of the properties of the image carrier 41, the charging member 42, and the high voltage generating circuit 91; in this embodiment, A=1.63 and B=−0.63.

Vsm=f(Vsc)=A×Vsc+B Formula 1

The initial voltage adjusting portion 53 gradually increases the peak-to-peak voltage until the amount of increase (amount of variation) in the value of the DC current Idc detected by the current detecting portion 96 is equal to or less than a predetermined value, and sets the value of the peak-to-peak voltage at this time as the target voltage value.

Referring to FIG. 10B, when the peak-to-peak voltage exceeds the discharge starting voltage which is caused by the DC voltage, the charge potential of the image carrier 41 is saturated and stops increasing, and thus the amount of variation of the DC current diminishes and settles at or below a predetermined value.

That is, the value of the peak-to-peak voltage immediately after the amount of variation of the DC current detected by the current detecting portion 96 has diminished to or below the predetermined value serves as the minimum peak-to-peak voltage used to set the charge potential of the image carrier 41 at a predetermined charge potential, and the value of the peak-to-peak voltage at which the amount of variation settles below the predetermined value is set as the target voltage value.

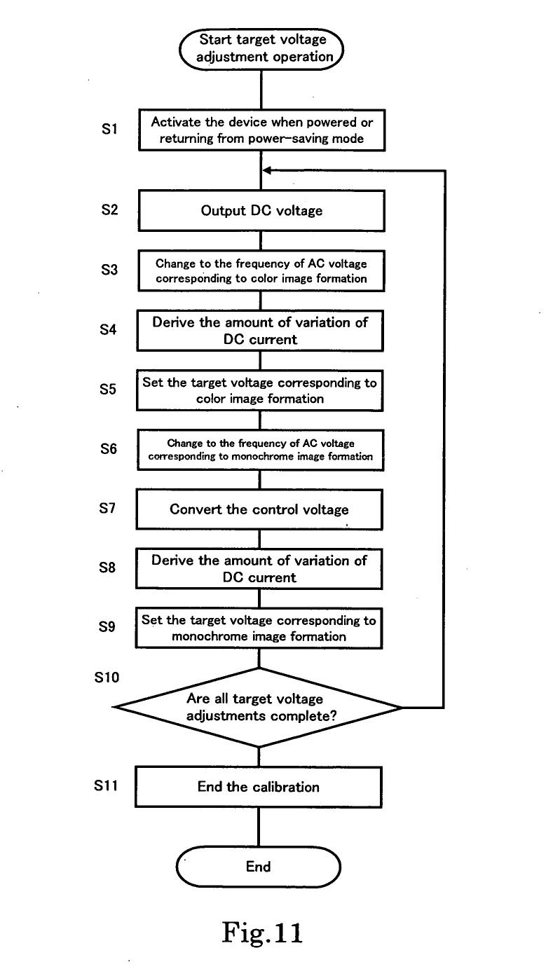

The adjusting operation of the target voltage by the initial voltage adjusting portion 53 will be described below by referring to the flowchart shown in FIG. 11.

When power is supplied to the color digital copier 100 or when the color digital copier 100 returns from a power saving mode (S1), the initial voltage adjusting portion 53 reads a target DC voltage from the ROM mounted in the imager carrier 41 for the image forming unit 4a of the four image forming units 4, and controls a control voltage Vcnt such that the DC voltage Vdc output from the shunt regulator 93 is the target DC voltage (400V in this embodiment) (S2).

The initial voltage adjusting portion 53 sets, through the frequency switching portion 52, the frequency of the AC voltage Vac at 1600 Hz, which is the frequency corresponding to the process speed during color image formation (S3), and adjusts the control voltage such that the peak-to-peak voltage of the AC voltage Vac output from the AC voltage power source 95 increases from 800V to 1200V on a 100V basis per 0.5 second.

Thus, the initial voltage adjusting portion 53 monitors the DC current Idc detected by the current detecting portion 96 while applying to the charging member 42 an oscillating voltage having a DC voltage Vdc and an AC voltage Vac superimposed thereon.

The initial voltage adjusting portion 53 sets, as the target voltage corresponding to the process speed during color image formation, the peak-to-peak voltage at the time when the amount of variation of the value of the DC current Idc is equal to or less than a predetermined value, and stores the control voltage to the AC voltage power source 95 at this time in the RAM of the image forming control portion 40 (S4 and S5).

Next, the initial voltage adjusting portion 53 sets, through the frequency switching portion 52, the frequency of the AC voltage Vac at 2200 Hz, which is the frequency corresponding to the process speed during monochrome image formation (S6), and adjusts the control voltage such that the peak-to-peak voltage of the AC voltage Vac output from the AC voltage power source 95 increases from 800V to 1200V on a 100V basis per 0.5 second.

On this occasion, the control voltage input to the AC voltage power source 95 is one that is converted by the control voltage adjusting portion 54 on the basis of formula 1 (S7).

Likewise, the initial voltage adjusting portion 53 sets, as the target voltage corresponding to the process speed during monochrome image formation, the peak-to-peak voltage at the time when the amount of variation of the value of the DC current Idc is equal to or less than a predetermined value, and stores the control voltage to the AC voltage power source 95 at this time in the ROM of the image forming control portion 40 (S8 and S9).

The initial voltage adjusting portion 53 repeats the control from the steps S2 to S8 for each of the remaining three image forming units 4b, 4c, and 4d. Upon completion of adjustment for all the image forming units 4 (S10), the initial voltage adjusting portion 53 ends the calibration of adjusting the target voltage (S11).

Other embodiments of the present invention will be described below.

While in the above embodiment the charging member 42 is disposed in contact with the image carrier 41, the present invention will find applications in the cases where the charging member 42 is disposed in proximity to the image carrier 41. The present invention will also find applications in the cases where a charging blade is employed instead of a charging roller as the charging member 42.

While in the above embodiment the initial voltage adjusting portion 53 adjusts the target voltage individually for every frequency, the target voltage may be adjusted for only one of the frequencies. In this case, the target voltage at another frequency can be obtained on the basis of the target voltage at the one frequency and correlations including the one represented by formula 1.

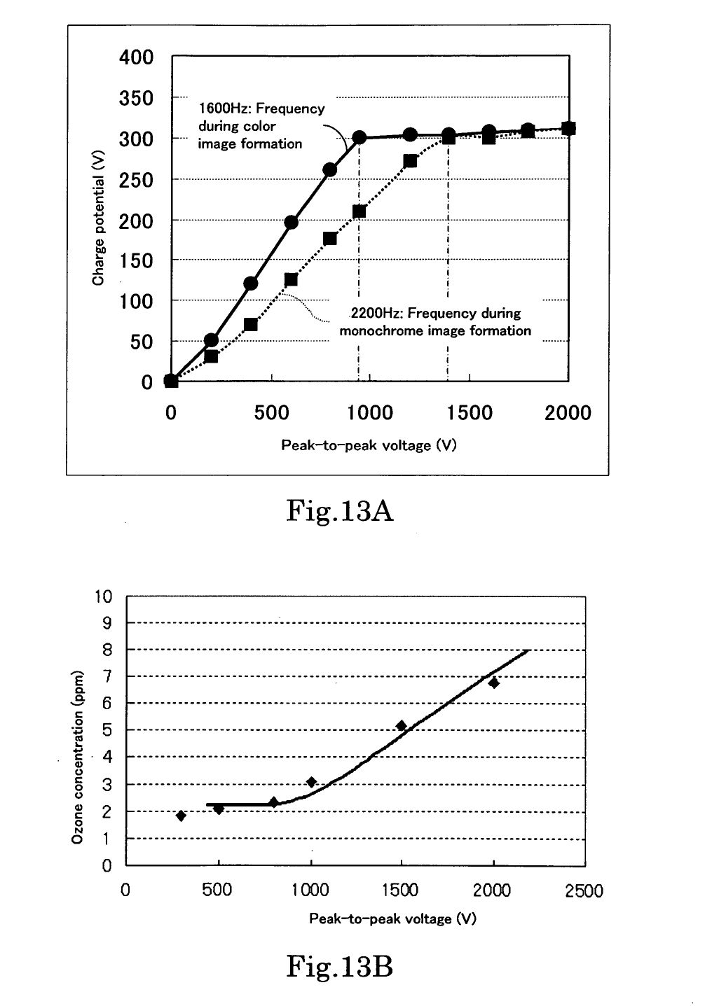

This will be described in detail below. Referring to FIG. 13A, a difference in the frequency of the AC voltage causes a shift in the peak-to-peak voltage for setting a predetermined charge potential. For example, the peak-to-peak voltage is approximately 1000 V at a frequency of 1600 Hz while shifting to approximately 1400 V at a frequency of 2200 Hz.

The impedance of the charging member has a temperature property such that at any frequency, the peak-to-peak voltage for setting a predetermined charge potential tends to increase as environmental temperature becomes low.

However, various experiments reveal that there is a constant correlation between the frequency of the AC voltage and the peak-to-peak voltage for setting a predetermined charge potential.

In view of this, the initial voltage adjusting portion 53 refers to the ROM that stores a correlation function or a conversion table for converting the control voltage for adjusting the target voltage at one of the frequencies into the control voltage for adjusting the target voltage at another frequency, thereby making it possible to calculate the target voltage at the other frequency from the target voltage adjusted at the one frequency.

While in the above embodiment the initial voltage adjusting portion 53 gradually increases the peak-to-peak voltage and sets as the target voltage the peak-to-peak voltage at the time when the amount of increase in the value of the DC current Idc detected by the current detecting portion 96 is equal to or less than a predetermined value, the adjustment of the target voltage according to the present invention will not be limited to this manner.

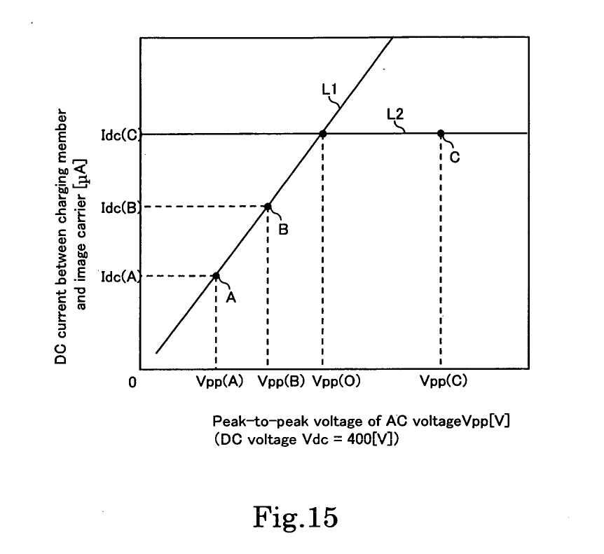

For example, referring to FIG. 15, obtain a line L1 passing through coordinate points A (Vpp(A), Idc(A)) and B (Vpp(B), Idc(B)) on an assumed characteristic curve that represents the relationship between the peak-to-peak voltage Vpp and the DC current Idc on a two-dimensional coordinate system. The coordinate points A and B are respectively determined by DC current values Idc(A) and Idc(B) when two different low voltage-side peak-to-peak voltages Vpp(A) and Vpp(B) are applied to the charging member in an area of lower voltage than the voltage value of an inflection point that appears when the peak-to-peak voltage Vpp increases.

Next, obtain a line L2 parallel to the coordinate axis for the peak-to-peak voltage Vpp and passing through a coordinate point C (Vpp(C), Idc(C)) on the assumed characteristic curve, the coordinate point C being determined by a DC current value Idc(C) when a single high voltage-side peak-to-peak voltage Vpp(C) is applied in an area of higher voltage than the voltage value of the inflection point.

Then, obtain a peak-to-peak voltage Vpp corresponding to the intersection of the lines L1 and L2 as a proper peak-to-peak voltage Vpp(O), and set the peak-to-peak voltage Vpp of the AC voltage at the peak-to-peak voltage Vpp(O).

While in the above embodiment the color digital copier is described as an example of the image forming device of the present invention, the image forming device of the present invention will also find applications in other image forming devices than copiers; for example, tandem image forming devices such as printers are possible insofar as the process speed can be changed by switching.

The present invention will also find applications in image forming devices that switch the process speed between a plurality of process speeds during color image formation or during monochrome image formation.

The above embodiments have been described by way of example and will not limit the present invention; it will be appreciated that various modifications can be made to the specific details of the constituent parts of the present invention without departing from the scope of the present invention.

What is claimed is:

1. A tandem image forming device having a charging member disposed in contact with or proximity to an image carrier and changing by switching a process speed depending on monochrome image formation and color image formation, the image forming device comprising:
a high voltage generating circuit for applying an oscillating voltage to the charging member, the oscillating voltage having a DC voltage and an AC voltage superimposed thereon;
a voltage control portion for controlling a peak-to-peak voltage of the AC voltage at a target voltage;
a current detecting portion for detecting the value of a DC current between the image carrier and the charging member;
a frequency switching portion for switching a frequency of the AC voltage between frequencies according to the process speed; and
an initial voltage adjusting portion for adjusting the target voltage on the basis of the value of the DC current detected by the current detecting portion.

2. The image forming device according to claim 1, wherein the initial voltage adjusting portion adjusts the target voltage for every frequency switched by the frequency switching portion.

3. The image forming device according to claim 1, wherein the initial voltage adjusting portion adjusts the target voltage at one of the frequencies switched by the frequency switching portion and sets the target voltage at another frequency on the basis of the adjusted target voltage, the target voltage at the other frequency being a value calculated on the basis of a frequency voltage property.

4. The image forming device according to claim 1, further comprising a control voltage adjusting portion for converting a control voltage for adjusting the target voltage at one of the frequencies into a control voltage for adjusting the target voltage at another frequency.

5. The image forming device according to claim 1, wherein the initial voltage adjusting portion gradually increases the peak-to-peak voltage until the amount of increase in the value of the DC current detected by the current detecting portion is equal to or less than a predetermined value, so as to adjust the target voltage.

6. The image forming device according to claim 1, wherein the initial voltage adjusting portion is activated when power is supplied to the image forming device or when the image forming device returns from a power saving mode.
